(19) United States
(12) Patent Application Publication
(10) Pub. No.: US 2011/0032182 A1
(43) Pub. Date: Feb. 10, 2011

(54) PORTABLE TERMINAL HAVING PLURAL INPUT DEVICES AND METHOD FOR PROVIDING INTERACTION THEREOF

(75) Inventors: Jin Yong KIM, Seoul (KR); Jung Yeob OH, Gyeonggi-do (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/849,873

(22) Filed: Aug. 4, 2010

(30) Foreign Application Priority Data
Aug. 10, 2009 (KR) 10-2009-0073129

(51) Int. Cl. G09G 5/00

(52) U.S. Cl. 345/156

(57) ABSTRACT

A portable terminal having plural input devices and a method for providing interaction thereof are provided. A method for providing interaction of a portable terminal having plural directional input devices, includes: receiving an interaction signal input from at least of the plural direction input devices; checking drive modes of the portable terminal; and executing a preset function by the drive modes corresponding to the interaction signal. The method may easily execute various functions through intuitive interaction using plural input devices thereby improving convenience for a user.

### CLAIM OF PRIORITY

This application claims the benefit under 35 US.C. §119(a) of a Korean patent application filed in the Korean Intellectual Property Office on Aug. 10, 2009 and assigned Serial No. 10-2009-0073129, and the entire disclosure of which is hereby incorporated by reference

### BACKGROUND OF THE INVENTION

1. Field of the Invention

The present invention relates to a portable terminal having plural input devices for providing various interactions to improve convenience for a user and a method for providing input interaction thereof.

2. Description of the Related Art

In general, a portable terminal such as a portable phone may execute multiple functions with various functions, such as SMS transmitting and receiving function, digital broadcasting receiving function, music-reproducing function as well as a basic voice call function. Such a portable terminal may include at least one input device controlling and executing the various functions. The input device typically includes a button type keypad, a touch screen, a touch pad, a joystick, an optical joystick, a wheel key, and a track ball. Such an input device transmits a user command to a controller (CPU) according to a previous defined operation type.

However, most input devices provide a limited interaction during operation. Accordingly, there is a need for an improved way of providing various interactions using plural input devices, thus enhancing the use of a portable terminal.

### SUMMARY OF THE INVENTION

The present invention provides a portable terminal for providing intuitive interaction using plural input devices, thereby improving convenience for a user, and a method for providing the improved interaction thereof.

In accordance with an aspect of the present invention, a method for providing interaction of a portable terminal having a plurality of directional input devices includes: receiving an interaction signal input from at least one of the plurality of direction input devices; checking drive modes of the portable terminal; and executing a preset function according to the drive mode and the interaction signal.

In accordance with another aspect of the present invention, a portable terminal includes: an input unit with a plurality of directional input devices; and a controller checking drive modes of the portable terminal when an interaction signal is input from at least one of the plurality of directional input devices, and executing a preset function corresponding to the drive modes and the interaction signal.

### BRIEF DESCRIPTION OF THE DRAWINGS

The above and other aspects, features, and advantages of certain exemplary embodiments of the present invention will be more apparent to those skilled in the art from the following description taken in conjunction with the accompanying drawings, in which:

FIGS. 1a and 1b are views schematically illustrating a portable terminal according to an exemplary embodiment of the present invention, respectively;

FIG. 2 is a block diagram illustrating a schematic configuration of a portable terminal according to an exemplary embodiment of the present invention;

FIG. 3 is a flow chart illustrating a method for providing interaction of a portable terminal according to an exemplary embodiment of the present invention; and

FIGS. 4 to 6 are views illustrating examples of a screen according to an exemplary embodiment of the present invention, respectively.

### DETAILED DESCRIPTION OF THE INVENTION

Exemplary embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

Hereinafter, it is to be understood that the following disclosure is provided for exemplary purposes only and is not intended as a limitation of the present invention. Furthermore, all alternate embodiments which are obvious modifications of this disclosure are intended to be encompassed within the scope of the present invention.

It should be noted that the teachings of the present invention is applicable to all types of information and communication devices and multi-media devices such as digital broadcasting terminals, Personal Digital Assistant (PDA), Smart Phone, Portable Multimedia Player (PMP) terminals, International Mobile Telecommunication 2000 (IMT-2000) terminals, Code Division Multiple Access (CDMA) terminals, Wideband Code Division Multiple Access (WCDMA) terminals, Global System for Mobile communication (GSM) terminals, Universal Mobile Telecommunication Service (UMTS) terminals, note book computers, Ultras Mobile Personal Computer (UMPS), or PMP.

In the specification, “interaction” refers to a previously defined operation to transfer a user's command to a portable terminal. Namely, a user can perform a specific operation using an input unit to execute a previously defined function.

In the specification, “interaction combination” refers to interaction which a user combines signals input from plural input devices to define as one input signal.

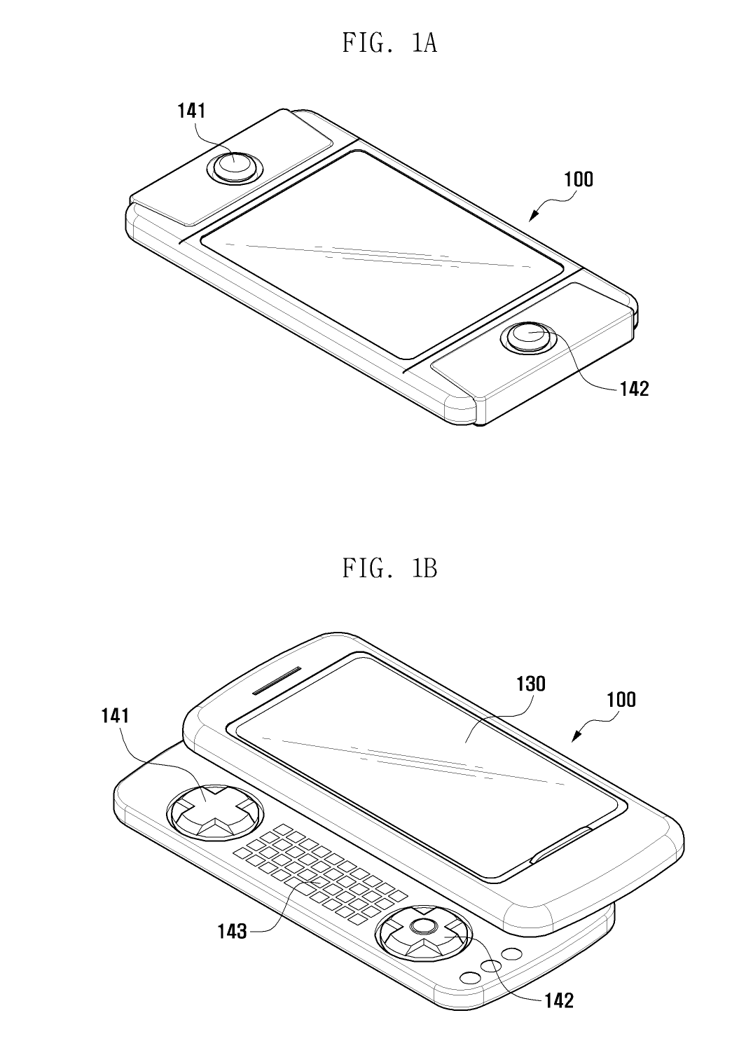

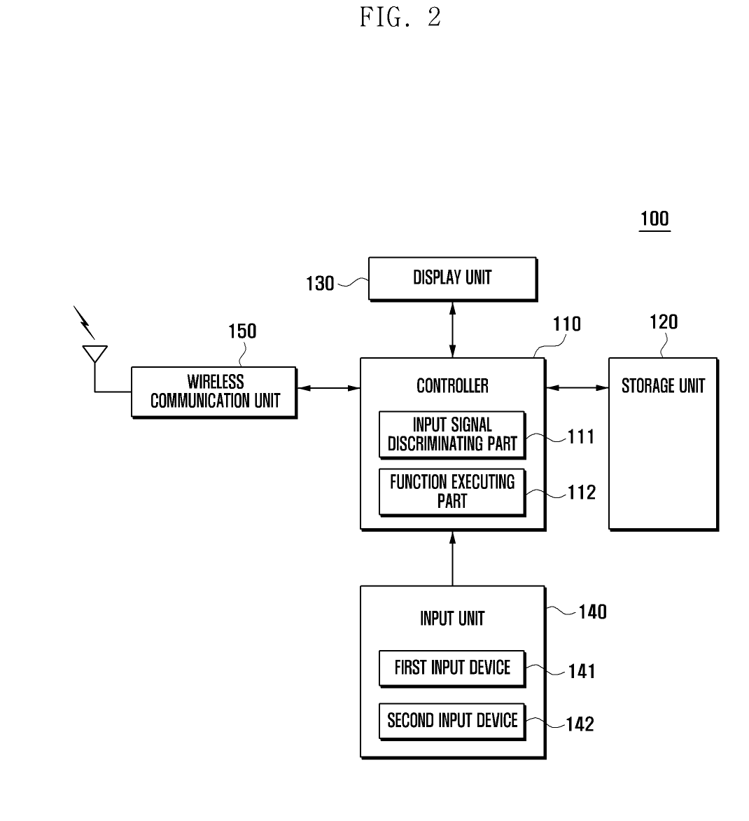

FIGS. 1a and 1b illustrate an outer appearance of two types of a portable terminal according to an exemplary embodiment of the present invention, respectively, and FIG. 2 is a block diagram illustrating a schematic configuration of a portable terminal according to an exemplary embodiment of the present invention.

Referring to FIG. 1a and FIG. 2, the portable terminal 100 according to an exemplary embodiment of the present invention may include a wireless communication unit 150, an input unit 140, a display unit 130, a storage unit 120, and a controller 110.

In operation, when interaction signals are input to the portable terminal 100 having a structure as described above from plural input devices, it may check drive modes of the portable terminal 100 to execute a preset function by the drive modes corresponding to the interaction signals. The drive modes may include (1) a combination mode executing a specific function according to a combination of signals input from the plural directional input devices; (2) a division mode controlling a plurality of areas by different directional input devices; (3) a multi-tasking mode executing a plurality of application programs; and (4) a web page mode outputting a web page.

For illustrative purposes, the portable terminal 100 according to an embodiment of the present invention may provide intuitive interaction using the two directional input devices. However, the present invention is not limited thereto. For example, the present invention may provide intuitive interaction using three or more directional input devices.

Referring to FIG. 1a, first and second input devices 141 and 142 capable of inputting a directional signal are provided at left and right sides of the display unit 130, respectively. In alternate embodiment, as shown in FIG. 1b, the portable terminal 100 can be comprised of an upper body including the display unit 130 and a lower body including an input unit. In this case, the lower body may include a key pad 143 for inputting characters or numbers, and directional input devices 141 and 142 provided next to the key pad 143. For illustrative purposes, the portable terminal 100 according to an embodiment of the present invention may provide intuitive interaction using two directional input devices 141 and 142 to improve convenience for user, as explained later. However, the portable terminal 100 according to an embodiment of the present invention is not limited to shapes shown in FIGS. 1a and 1b. Namely, the portable 100 according to the present invention can be formed to have various types such as slide or folder, and the plural input devices 141 and 142 can be mounted on plural locations. Hereinafter, respective structural elements of the portable terminal 100 according to the present invention will now be described in detail.

The wireless communication unit 150 performs a communication function of the portable terminal 100. The wireless communication unit 150 forms a communication channel with a wireless network including a base station to perform speech communication, data communication, and the like. The wireless communication unit 150 can be configured by a radio frequency (RF) transmitter (not shown) up-converting a frequency of a transmitted signal and amplifying the signal, and an RF receiver (not shown) low-noise-amplifying a received signal and down-converting the signal. In particular, the wireless communication unit 150 according to an embodiment of the present invention may transmit contents data such as photographs and motion images to the base station through a web server in response to an upload request of contents (e.g., photographs, moving images, or the like) from the input unit 140. Otherwise, when the portable terminal 100 includes a near distance wireless communication module such as a wireless LAN, WiFi, or WiBro, it may transmit the contents data to the web server through Internet.

The input unit 140 may receive input of numeric or various character information, and include input keys for setting all type of functions and function keys for controlling functions of the portable terminal 100. The input unit 140 can be configured by one or a combination of plural input means such as button type key-pad, joystick, optical joystick, touch key, track ball, or wheel key. In particular, the input unit 140 according to an embodiment of the present invention may include function keys changing drive modes of the portable terminal 100. The input unit 140 may include a first input device 141 and a second input device 142.

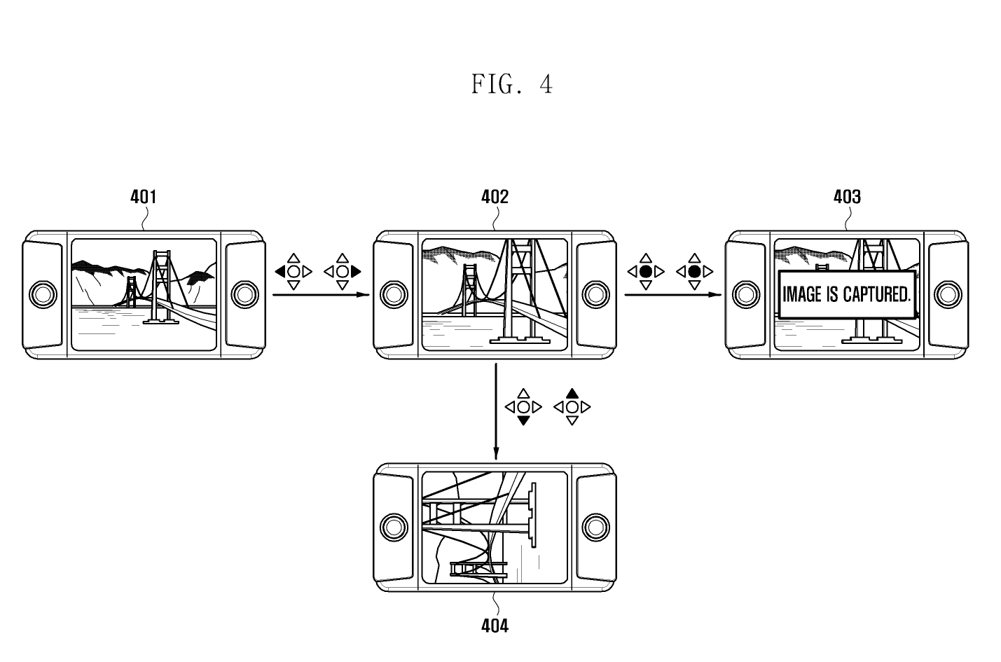

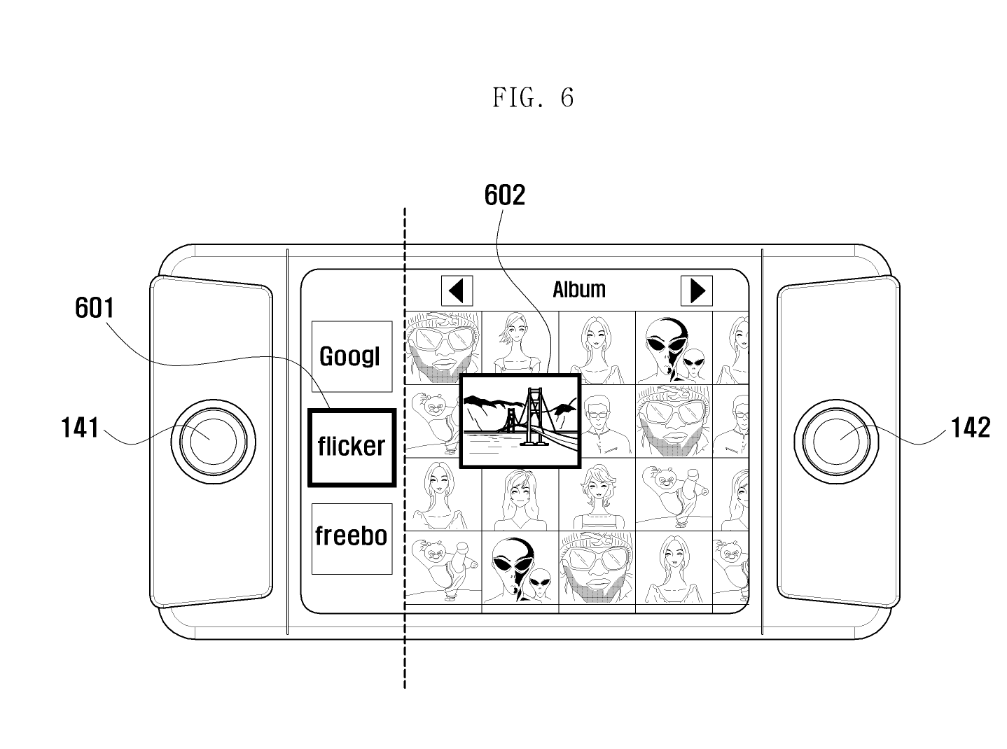

As described above, the first input device 141 and the second input device 142 can be configured by various types. The first input device 141 and the second input device 142 may be configured by the same type or different types. Hereinafter, for convenience of a description, a thumb-pad type joystick being a directional input device is described as an example of the first input device 141 or the second input device 142. In particular, the first input device 141 and the second input device 142 may transmit various interaction combination signals according to an embodiment of the present invention. The interaction combination signal will be explained with reference to a storage unit 120 and FIGS. 4 to 6 below. Further, the first input device 141 and the second input device 142 may control different areas when a screen is output to be divided into plural areas. Meanwhile, when a plurality of application programs is executed, the first input device 141 and the second input device 142 may control different application programs. A detailed description thereof will be described later with reference to FIG. 6.

The display unit 130 may display screen data, state information such as a user's input events and key operations, and function set information of the portable terminal 100 during the execution of functions of the portable terminal 100. Furthermore, the display unit 130 may visibly display various signals and color information output from the controller 110. The display unit 130 can be configured by Liquid Crystal Display (LCD) or Organic Light-Emitting Diode (OLED). Alternatively, the display unit 130 can be configured by a touch screen type according to a providing type of the portable terminal 100. In this case, the display unit 130 may operate as the input unit 140. In particular, the display unit 130 according to the present invention may output a screen executing a preset function corresponding to an interaction combination using the first input device 141 and the second input device 142. For example, the display unit 130 may zoom-in, zoom-out, or rotate a screen corresponding to the interaction combination. Otherwise, the display unit 130 may output an edit screen editing contents corresponding to the interaction. Examples of screens and operation of the display unit 130 will be described with reference to FIGS. 4 to 6 below.

The storage unit 120 may store programs necessary to execute overall operations and a specific function of the portable terminal 100, data generated during execution of the programs, and user data. The storage unit 120 may include a program area and a data area. The program area may store an Operating System (OS) booting the portable terminal 100 and application programs necessary in a function operation of the portable terminal 100. For example, the program area may include a music-reproducing program, a moving image-reproducing program, and a web access program. In particular, the program area according to the present invention may include an interaction application program that checks drive modes of the portable terminal 100 to execute a specific function by the drive modes corresponding to an interaction signal using plural input devices. When the drive mode is a combination mode, the interaction application program may execute functions such as zoom-in, zoom-out, rotation, excision, copy, capture, edition, adding favorites corresponding to the interaction combination using the plural input devices. The interaction application program may include an option control menu changing a specific function mapped to the interaction combination by a user, generating another interaction combination and mapping a specific function to the generated interaction combination. Namely, the user may create various interaction combinations according to the user's taste through the option control menu. When the drive mode is a multi-tasking mode or a division mode, the interaction application program may check input devices allotted to respective application programs or areas, and control corresponding application programs or areas according to interaction signal from the allotted input devices. Moreover, the interaction application program may allot a pointer moving function of a mouse to one (first input device) of the plural directional input devices upon outputting a web page, and allot an option menu function such as a button of the mouse to another direction input device (second input device).

The data area may store data generated according to a use of the portable terminal 100. For example, the data area may store phone books and contents (photographs, moving images, music files, or the like). In particular, the data area according to the present invention may store a mapping table that maps functions to the interaction combination as illustrated in Table 1.

TABLE 1

| Interaction combination | | |
|---|---|---|
| First input device | Second input device | Functions |
| □ | □ | Zoom-in |
| □ | □ | Zoom-out |
| ▴ | ▾ | Rotation clockwise |
| ▾ | ▴ | Rotation counterclockwise |
| ▪ | ▪ | Capture |
| ▴ | ▴ | Adding favorites |
| ▾ | ▾ | Edition |
| . | . | . |
| . | . | . |
| . | . | . |

Referring to Table 1, note that a specific function is mapped to an interaction combination of the first input device 141 and the second input device 142. For example, when a left key of the first input device 141 and a right key of the second input device 142 are simultaneously input, a screen can zoom-in. Conversely, when a right key of the first input device 141 and a left key of the second input device 142 are simultaneously input, a screen can zoom-out. Further, when an up key of the first input device 141 and a down key of the second input device 142 are simultaneously input, a screen can rotates clockwise. In this case, whenever the up key of the first input device 141 and the down key of the second input device 142 are simultaneously input, the screen can be controlled to rotate by 90°. Meanwhile, until inputs of the up key of the first input device 141 and the down key of the second input device 142 are cancelled, the screen may be controlled to rotate in a constant speed. In this case, the present invention may control the rotating speed to become gradually higher. Conversely, when a down key of the first input device 141 and an up key of the second input device 142 are simultaneously input, a screen can rotate counterclockwise. In a state that the first input device 141 and the second input device 142 are disposed in a center, when the first input device 141 and the second input device 142 are simultaneously pushed, a screen capture function can be executed. When the up key of the first input device 141 and the up key of the second input device 142 are simultaneously input, a favorites adding function may be executed. When a favorites adding function signal is input during web surfing, the controller 110 may add a web site address during the surfing to a favorites adding item. Moreover, when the down key of the first input device 141 and the down key of the second input device 142 are simultaneously input, an editing function can be executed. For example, when the editing function signal is input in a state that an image such as a photograph is output, an image edition program can be executed. As used herein, the term “simultaneously” does not mean the completely same moment. For example, the “simultaneously” can be regarded to generate two signals when an input signal is generated from the first input device 141, and an input signal is generated within several ms from the second input device 142.

Note that the foregoing Table 1 should not limit the present invention, and that different combination of input via two key inputs can generate other variation of user manipulation. When the first input device 141 and the second input device 142 can have eight directions input function or a forward input function (360°), they may provide various interaction combinations. Furthermore, a function mapped to an interaction combination of the first input device 141 and the second input device 142 can be various set according to a user's intention. For example, the user may change a mapped function using the option control menu. Further, the user may create a new interaction combination using the option control menu. The foregoing embodiment has described that respective input devices may have one directional signal and combine the signals. However, the present invention is not limited thereto. Namely, the respective input devices may have at least two directional signals and combine them. For example, in a state that the first input device 141 is pushed or activated, when the second input device 142 sequentially moves to upward direction, left direction, and downward direction, namely rotates to have a “C” shape, a copy function can be executed.

The controller 110 may perform an overall operation control function of the portable terminal 100, control signal flows between structural elements in the portable terminal 100, and perform a data processing function. In particular, when a signal from at least one of the first input device 141 and the second input device 142 is input to the controller 110 according to an embodiment of the present invention, it may check drive modes of the portable terminal 100 and execute a preset function by the drive modes. To do this, the controller 110 may include an input signal discriminating part 111 and a function executing part 112.

The input signal discriminating part 111 senses key signal inputs of the first input device 141 and the second input device 142. When the drive mode of the portable terminal 100 is a combination mode, the input signal discriminating part 111 may combine interaction signals input from the first input device 141 and the second input device 142 to output an interaction combination signal. Next, the input signal discriminating part 111 may search the mapping table to check a function mapped to the interaction combination signal, and request the function executing part 112 to execute the searched function. When the drive mode of the portable terminal 100 is a multi-tasking mode, the input signal discriminating part 111 discriminates signals input from the first input device 141 and the second input device 142 by application programs. In the same manner, when the drive mode of the portable terminal 100 is a division mode, the input signal discriminating part 111 may discriminate signals input from the first input device 141 and the second input device 142 by areas. Then, the input signal discriminating part 111 transmits the signals discriminated by the application programs or the areas to the function executing part 112 such that the function executing part 112 may execute a function in which a corresponding application program or a corresponding area is set the signal.

The function executing part 112 may execute a specific function according to a request of the input signal discriminating part 111. For example, the function executing part 112 may execute functions such as zoom-in, zoom-out, rotation, capture, adding favorites, excision, copy, insertion, edition, corresponding to the interaction combination of the first input device 141 and the second input device 142. When the drive mode of the portable terminal 100 is the division mode or the multi-tasking mode, each application program or area can execute a corresponding to according to the signal discriminated by the input signal discriminating part 111. For example, when the music-reproducing program or a document-seeing program is executed, the function executing part 112 may control functions associated with a music-reproducing program such as reproducing a next music or reproducing a previous music using the first input device 141, and functions associated with a document-seeing program such as up, down, left and right movement using the second input device 142. As described previously, since input devices allotted to respective programs are discriminated, the function executing part 112 can control a document-seeing program and the music-reproducing program. A detailed description thereof will be described with reference to FIG. 6 below.

The function executing part 112 may control the movement of a pointer corresponding to an input signal of the first input device 141 to which a moving function is set upon outputting a web page, and execute a function allotted to the second input device 142 upon generating a signal from the second input device 142 to which an option control function is set.

In the meantime, FIG. 2 shows a schematic configuration of the portable terminal 100 for convenience of a description. However, the portable terminal 100 according to the present invention is not limited to the foregoing configuration. For example, the portable terminal 100 may selectively include structural elements with additional functions such as a camera module for photographing images or moving images, a near distance communication module for near distance communication, a broadcasting receiving module for receiving broadcast, a digital sound source reproducing module, and an Internet communication module communicating with Internet to perform Internet function. Such structural elements can be variously changed according to convergence trend. However, the portable terminal according to the present invention may further include structural elements equivalent to the foregoing structural elements.

The following is a description of an outer appearance and a configuration of the portable terminal 100 according to an embodiment of the present invention.

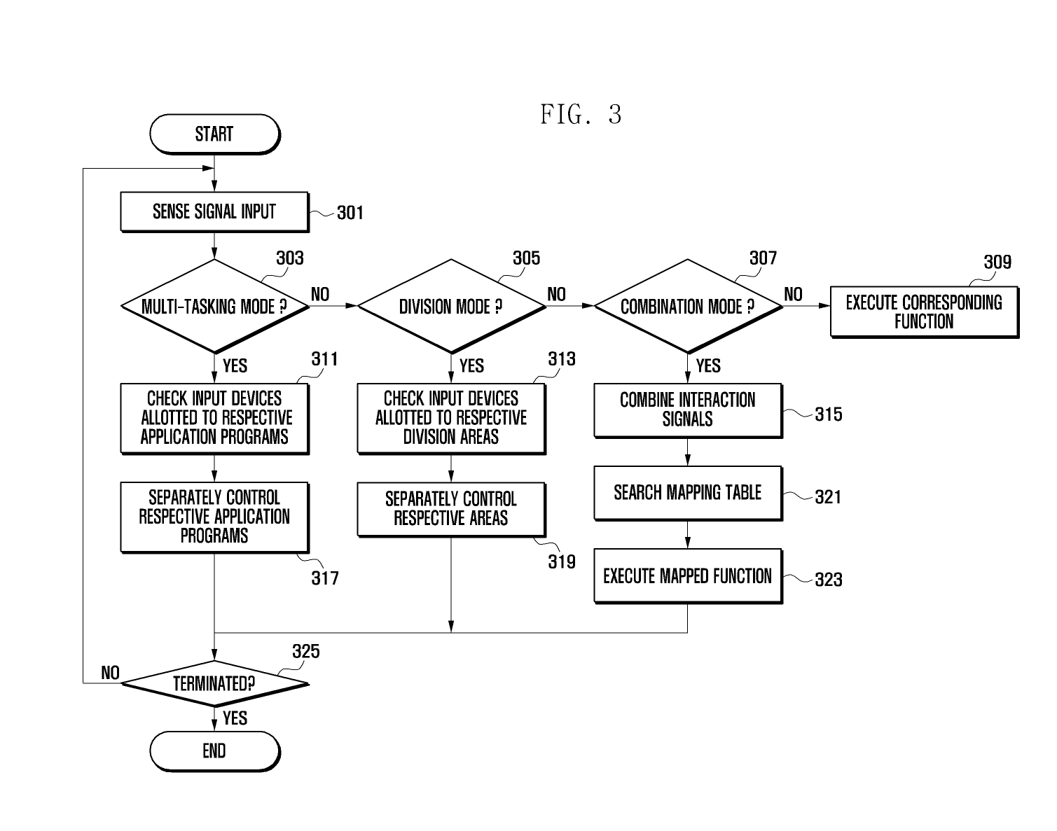

FIG. 3 is a flow chart illustrating a method for providing user interaction of a portable terminal according to an exemplary embodiment of the present invention.

Referring to FIGS. 2 and 3, a controller 110 may sense a signal input from at least one of a first input device 141 and a second input device 142 (301). Next, the controller 110 may check whether a drive mode of a portable terminal 100 is a multi-tasking mode executing a plurality of application programs (303). When the drive mode of a portable terminal 100 is the multi-tasking mode, the controller 110 may check input devices allotted to respective application programs (311). Next, the controller 110 may control a function corresponding to a signal input to application programs allotted to the first input device 141 and the second input device 142 to be executed (317). For example, if a music-reproducing program and a document-seeing program are simultaneously executed, the controller 110 executes functions associated with the music-reproducing program such as reproducing a next music or reproducing a previous music according to a signal input from the first input device 141, and functions associated with a document-seeing program such as up, down, left and right movement according to a signal input from the second input device 142. As mentioned above, in the present invention, input devices allotted to respective application programs may be discriminated to control the document-seeing program and the music-reproducing program, respectively. When a mode is changed in the multi-tasking mode according to user's selection, plural input devices may be combined to execute a specific function, for example, zoom-in, zoom-out, capture and the like. To do this, the present invention may include a mode change procedure. When a mode change is requested in a multi-tasking mode set to control the music-reproducing program and the document-seeing program, the controller 110 may control only one of the music-reproducing program and the document-seeing program using the plural input devices. At this case, the controller 110 may control to output a pop-up window selecting an application program to be controlled among activated application programs at the time of requesting a mode change.

Conversely, when the drive mode is not a multi-tacking mode, the controller 110 can check whether the drive mode is a division mode in which plural areas are controlled by different directional input devices (305). For example, the division mode may be a mode displaying a contents upload menu that includes a first area allotted to the first input device 141 for displaying a plurality of web site logos and a second area allotted to the second input device 142 for displaying a contents list. When the drive mode is the division mode at step 305, the controller 110 may check input devices allotted to respective division areas (313). Subsequently, the controller 110 may control a function corresponding to a signal input to an area allotted to the first input device 141 and the second input device 142 to be executed (319). For example, when the contents upload menu is activated, the controller 110 may move a focus of a first area corresponding to an input signal of the first input device 141 to select a specific web site logo, and may move a focus of a second area corresponding to an input signal of the second input device 142 to select contents to be uploaded. Next, a preset upload signal is input to the controller 110, it may upload contents selected using the first input device 141 in a specific web site selected using the second input device 142. Meanwhile, when a mode is changed according to user's selection in the division mode, the plural input devices may be combined to execute a specific function, for example, zoom-in, zoom-out, capture and the like. To do this, the present invention may further include a mode change procedure. In other words, when a mode change is requested in the division mode set to respectively control divided areas, the controller 110 may control one of the divided areas using the plural input devices. In this case, when the mode change is requested, the controller 110 may output a pop-up window selecting one of the divided areas.

Meanwhile, when the drive mode is not the division mode at step 305, the controller 110 checks whether the drive mode is a combination mode in which input signals are simultaneously generated in the first input device 141 and the second input device 142 (307). When the drive mode is the combination mode, the controller 110 combines interaction signals input from the first input device 141 and the second input device 142, and generates an interaction combination signal (315). The controller 110 may search a mapping table stored in the storage unit 120 to check a function mapped to the interaction combination signal (321). Next, the controller 110 can execute the mapped function (323).

To the contrary, when the drive mode is not the combination mode at step 307, the controller 110 may execute a corresponding function (309). Namely, the controller 110 may execute a function corresponding to a signal input from one of the plural input devices. For example, when a down key of the first input device 141 is input in a state that a call list is output, the controller 110 may move a focus downwards.

After performing steps 317, 319, and 324, the controller 110 may check whether the portable terminal 100 is terminated (325). When the portable terminal 100 is not terminated, the controller 110 goes to step 301 and repeats next procedures. Conversely, when the portable terminal 100 is terminated, the controller 110 performs a termination procedure.

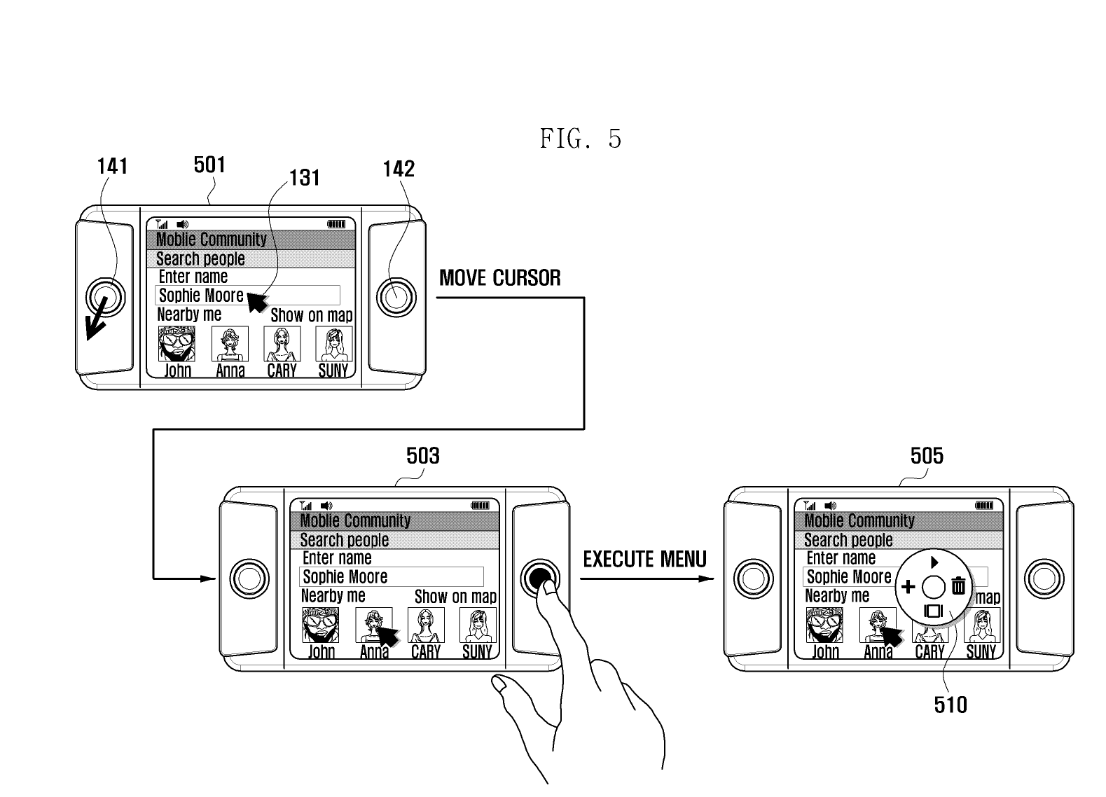

In the meantime, although not shown, upon outputting a web page, the controller 110 may allot a pointer moving function to the first input device 141, and allot an option menu function executing a specific function to the second input device 142. Namely, the present invention provides a mouse function of a PC using two directional input devices 141 and 142, namely, an interface similar to the PC, thereby improving convenience for a user. A detailed description thereof will be given later with reference to FIG. 5.

The foregoing embodiments have described a method for providing interaction in a portable terminal including plural input devices according to the present invention. Hereinafter, a used example of the present invention will be described through an exemplary drawing of a screen by drive modes in detail.

FIG. 4 is a view illustrating an example of a screen executing various functions according to interaction combination upon outputting a specific image according to an embodiment of the present invention.

Referring to FIGS. 2 and 4, a display unit 130 may output a specific image (e.g, photo image) with a constant ratio like a screen 401. Next, when a user simultaneously pushes a left key of the first input device 141 and a right key of the second input device 142, the display unit 130 may zoom-in to output the specific image like a screen 402 under the control of the controller 110. In this case, each time a signal simultaneously pushing the left key of the first input device 141 and the right key of the second input device 142 is input, the zoom-in can be performed by stages. While the signal simultaneously pushing the left key of the first input device 141 and the right key of the second input device 142 is being input, the controller 110 may increase speed with a constant rate or gradually to zoom-in to a preset maximum value. Here, the controller 110 may magnify only an item selected, namely, focused by a user upon zoom-in at a screen with an output list. When the list is output as the Graphic User Interface (GUI) element (e.g., icon), the size of the GUI element is increased. When the list is output as text, the size of the text can be increased.

When a user simultaneously pushes the first input device 141 and the second input device 142 on a screen 402 in a state that the first input device 141 and the second input device 142 are positioned at a center, the controller 110 may capture an image output on a screen. At this time, the display unit 130 may output a pop-up message indicating that an image is captured such as a screen 403.

Meanwhile, when a user simultaneously pushes a down key of the first input device 141 and a up key of the second input device 142 on the screen 402, the display unit 130 may rotate and output the image counterclockwise by 90° such as the screen 404. As illustrated previously, the present invention may easily execute various functions through intuitive interaction using two directional input devices 141 and 142, thereby improving convenience for a user.

FIG. 5 is a view illustrating an example of a screen for explaining a used example of interaction of the input device upon outputting a web page according to an embodiment of the present invention.

Referring to FIGS. 2 and 5, the display unit 130 may output a web page corresponding to a user's selection. In this case, the display unit 130 may output only a part of the web page such as a screen 501 due to a limit of the size. At this time, the display unit 130 may output a pointer 131. When the web page is output, the first input device 141 may execute a moving function of the pointer 131, and the second input device 142 may execute an option control function capable of executing a specific function. The first input device 141 for controlling a movement of the pointer 131 may preferably sense a forward movement (360°).

When a user moves the first input device 141 to a lower left end on the screen 501, the pointer 131 can move to a lower left end corresponding to movement of the first input device 141 like a screen 503. At this time, if the user pushes the second input device 142, the display unit 130 may output a function image 510 displaying a function mapped to respective arrow keys on a side of a screen. The user can check the function image 510 to operate the second input device 142 to a direction mapped to a function to be executed. The function image 510 can be changed according to a location of the pointer 131. Namely, when the second input device 142 is pushed in a state that the pointer 131 is located at a displayed area of an image, the display unit 130 may output a function image 510 to which functions such as image storage, image enlargement, image reduction, image edition are set. When the second input device 142 is pushed in a state that the pointer 131 is located at a displayed area of moving image contents, the display unit 130 may output a function image to which functions such as moving image reproducing, moving image storage, link open, adding favorites are set. Next, the controller 110 may check a directional signal input from the second input device 142 to execute a function corresponding to the input directional signal. For example, if a right signal is input on a screen 505, the controller 110 may remove a corresponding file. As illustrated earlier, the present invention provides a mouse function of a PC using two directional input devices 141 and 142, namely, an interface similar to the PC, thereby improving convenience for a user.

FIG. 6 is a view illustrating a method for providing interaction in a divided screen according to an embodiment of the present invention.

Referring to FIGS. 2 and 6, the display unit 130 may output a screen divided into a plurality of areas controlled by different input devices. Hereinafter, a screen divided into a plurality of areas is described by way of example. The screen divided into areas may be a contents upload menu screen uploading photographs as shown in FIG. 6 on a specific web site. Namely, the contents upload menu screen can be divided into an area (referred to as ‘first area’ hereinafter) which at least one logo image indicating a web site uploading a photograph based on a dotted line outputs, and an area (referred to as ‘second area’ hereinafter) which outputs photographs stored in an album of a portable terminal in a thumbnail form. Here, an area division of the contents upload menu and information regarding input devices allotted to respective areas can be previously stored in the storage unit 120.

At this time, the user may select one of plural logos using the first input device 141 and select one of plural thumbnail images using the second input device 142. Namely, the user can move a focus 601 of a first area using the first input device 141 and move a focus 602 of a second area using the second input device 142. After the user selects a specific web site logo and a specific thumbnail using the first input device 141 and the second input device 142, if the user pushes the first input device 141, a photograph corresponding to the specific thumbnail can be uploaded on the specific web site. To do this, the web site log can contain a web site address, a user ID, a password, and folder information to be uploaded. As mentioned above, the present invention may simultaneously select an image and a web site to be uploaded using plural input devices. Namely, unlike the related art, after selection of an image to a second area, the user does not move a focus to a first area to change a web site, and can easily change a web site to be uploaded using the first input device 141. Therefore, the present invention may improve convenience for a user.

The foregoing embodiments have been described that divided screens are separately controlled using different input devices. However, the present invention is not limited thereto. Namely, when a plurality of application programs is executed, the present invention may simultaneously control the application programs using different input devices, respectively. To do this, the controller 110 may allot the input devices according to an execution order of the application programs. Further, the controller 110 may set to control a currently activated application program by the first input device 141 and control a previously activated application program by the second input device 142. To do this, the storage unit 120 may temporarily store an activation history of the application program.

In summary, the present invention relates a method for providing interaction in a portable terminal using plural input devices. When an interaction signal is input from at least one of the plural input devices, drive modes of the portable terminal are checked to execute a preset function by drive modes corresponding to the interaction signal. The drive modes may include a combination mode executing a specific function according to a combination of signals input from the plural input devices, a multi-tasking mode executing a plurality of application programs, a division mode allotting different input devices to a plurality of areas, and a web page mode outputting a specific web page. The present invention can separately control a plurality of application programs or areas using the plural input devices, and map a specific function, for example, zoom-in, zoom-out, copy, removal, edition, rotation, capture, adding favorites to the interaction combination using the plural input devices so that a user can easily perform frequently used functions. That is, the present invention may provide intuitive and convenient interaction using plural directional input devices. In particular, the present invention may change a function mapped to the interaction combination or create a new interaction combination, thereby improving convenience for a user. Further, the present invention may allot a pointer moving function and an option control menu function using a right button of a mouse to plural input devices to provide an environment similar to a user interface of a PC, with the result that convenience for a user can be improved.

As is clear from the forgoing description, in a portable terminal including plural input devices and a method for providing interaction thereof, various interactions are provided to improve convenience for a user. Further, the present invention may simultaneously control different application programs using the plural input devices to enhance convenience for a user. Moreover, the present invention may execute various functions without covering a screen like a touch input to improve convenience for a user. In addition, the present invention allows a user to create and change interaction and a function mapped thereto using plural input devices to significantly improve convenience for a user.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method for providing an interaction in a portable terminal having a plurality of directional input devices, the method comprising:
receiving an interaction signal input from at least one of the plurality of direction input devices;
checking a drive mode of the portable terminal; and
executing a preset function corresponding to the drive mode and the interaction signal.

2. The method of claim 1, wherein the drive mode comprises: at least one of
a combination mode executing a specific function according to a combination of signals input from the plurality of directional input devices;
a division mode controlling a plurality of areas of a screen of the portable terminal;
a multi-tasking mode executing a plurality of application programs; and
a web page mode outputting a web page.

3. The method of claim 2, wherein executing the preset function comprises:
combining interaction signals input from the plurality of directional input devices when the drive mode is a combination mode; and
searching a mapping table mapping the combined interaction signals to a specific function.

4. The method of claim 3, further comprising at least one of:
changing the specific function mapped to the combined interaction signals stored in the mapping table; and
adding a new interaction combination.

5. The method of claim 2, further comprising:
allotting different input devices to the plurality of application programs according to a preset rule when the plurality of application programs are executed.

6. The method of claim 5, wherein allotting different input devices sequentially allot preset input devices according to an execution order of the plurality of application programs.

7. The method of claim 5, wherein executing the preset function comprises:
checking input devices allotted to respective application programs when the drive mode is the multi-tasking mode; and
controlling application programs in response to an interaction signal of the allotted input devices.

8. The method of claim 2, wherein executing the preset function comprises:
checking input devices allotted to respective areas when the drive mode is the division mode; and
controlling respective areas corresponding to an interaction signal of the allotted input devices.

9. The method of claim 2, wherein executing the preset function comprises:
allotting a moving function of a pointer to one of the plural directional input devices when the drive mode is the web page mode; and
allotting an option menu function capable of executing a specific function to another of the plural directional input devices.

10. The method of claim 2, wherein the drive mode comprises a plurality of modes operating using the plurality of direction input devices.

11. A portable terminal comprising:
an input unit comprising a plurality of directional input devices; and
a controller checking drive modes of the portable terminal when an interaction signal is input from at least one of the plurality of directional input devices, and executing a preset function in response to the drive modes and the interaction signal.

12. The portable terminal of claim 11, wherein the controller combines interaction signals input from the plurality of directional input devices when the drive mode is a combination mode executing a specific function according to combination of signals input from the plurality of directional input devices, searches a mapping table mapping the combined interaction signals to the specific function, and executes a function mapped to the combined interaction signals.

13. The portable terminal of claim 12, further comprising a storage unit storing the mapping table and an option control menu changing the specific function mapped to the combined interaction signal or generating a new interaction combination.

14. The portable terminal of claim 11, wherein the controller allots different input devices to the plurality of application programs according to a preset rule when the plurality of application programs is executed.

15. The portable terminal of claim 14, wherein the controller sequentially allots preset input devices according to an execution order of the plurality of application programs.

16. The portable terminal of claim 11, wherein the controller checks input devices allotted to respective application programs when the drive mode is a multi-tasking mode executing a plurality of application programs to control application programs in response to interaction signals of the allotted input devices.

17. The portable terminal of claim 11, wherein the controller checks input devices allotted to respective areas when the drive mode is a division mode controlling the plural areas by different directional input devices to control areas in response to interaction signals of the allotted input devices.

18. The portable terminal of claim 11, wherein the controller allots a moving function of a pointer to one of the plural directional input device upon outputting a web page, and allots an option menu function capable of executing a specific function to another of the plural directional input devices.

19. The portable terminal of claim 11, wherein the drive mode comprises a plurality of modes operating using the plurality of direction input devices.
